(19) United States
(12) Patent Application Publication
(10) Pub. No.: US 2014/0321619 A1
(43) Pub. Date: Oct. 30, 2014

(54) X-RAY TUBE WITH HEATABLE FIELD EMISSION ELECTRON EMITTER AND METHOD FOR OPERATING SAME

(71) Applicant: KONINKLIJKE PHILIPS N.V., EINDHOVEN (NL)

(72) Inventors: Anand Kumar Dokania, Utrecht (NL); Gereon Vogtmeier, Aachen (DE); Peter Klaur Bachmann, Wuerselen (DE)

(21) Appl. No.: 14/360,661

(22) PCT Filed: Nov. 14, 2012
(86) PCT No.: PCT/IB2012/056417

§ 371 Date: May 27, 2014

Related U.S. Application Data
(60) Provisional application No. 61/563,870, filed on Nov. 28, 2011.

(51) Int. Cl. H01J 35/06

(52) U.S. Cl. CPC H01J 35/065; Y10S 977/939; B82Y 99/00
USPC 378/122; 977/939

(57) ABSTRACT

An X-ray tube, a medical X-ray device comprising such X-raytube and a method for operating such X-ray tube are proposed. The X-ray tube (1) comprises an electron emitter (3) with a substrate (4) having an electron emission surface (5). The electron emission surface (5) is adapted for field emission of electrons therefrom by providing a substantial roughness Such roughness may be obtained by applying carbon nano-tubes (19) onto the electron emission surface (5). A field generator (7) is provided for generating an electrical field adjacent to the electron emission surface (5) for inducing field emission of electrons therefrom. Furthermore, a heater arrangement (15) is provided and adapted for heating the electron emission surface (5) contemporaneous with the field emission of electrons. Accordingly, while electrons are emitted from the electron emission surface (5) due to a field effect, this electron emission surface (5) may also be heated to substantial temperatures of between 100 and 1000° C. It has been observed that such heating may stabilize electron emission characteristics as the emitter (3)as adsorbents or contaminations to the carbon nano-tubes may be reduced.

### FIELD OF THE INVENTION

The present invention relates to an X-ray tube, to a medical X-ray device comprising such X-ray tube and to a method of operating such X-ray tube.

### BACKGROUND OF THE INVENTION

X-ray radiography equipment may be used for various medical, analytical or other applications. For example, an X-ray tube may be used to emit X-rays for transmission through an object to be analyzed, wherein the transmitted X-rays are subsequently detected and characteristics of the analyzed object may be derived from the detected X-ray absorption.

For next generation X-ray radiography equipment, a high current combined with a small focal spot of an electron beam may be desired for high spatial resolution. For example, to minimize a motion-induced blurring of images of moving organs such as a heart, high temporal resolution may be desired which, inter alia, may depend on a switching time of an X-ray source used for acquiring the images.

In an X-ray source, electrons are emitted from a cathode serving as an electron emitter and are accelerated by an electrical field towards an anode. Conventionally, hot cathodes are used for thermionic electron emission, wherein the cathode is heated up to very elevated temperatures such that the energy of electrons in the cathode may exceed the work function of the material used for the cathode such that electrons may escape from the surface of the hot cathode and the freed electrons may then be accelerated towards an anode.

However, the above-mentioned combination of spatial and temporal resolution requirements may render a conventional hot cathode less suitable due to its non-Gaussian beam and slow response time, respectively. Furthermore, conventional electron emitters are generally not suitable for miniaturization of the X-ray tube.

Electron emitters using the field emission effect seem to meet the above spatial and temporal resolution requirements and have the potential to be an ideal electron source for next generation X-ray tubes.

For example, WO 2010/131209 A1 describes an X-ray source with a plurality of electron emitters using field emission.

However, it has been observed that field emission of electrons may depend on a variety of parameters which may result in non-stable electron emission.

### SUMMARY OF THE INVENTION

There may be a need for an X-ray tube, a medical X-ray device comprising an X-ray tube and a method for operating an X-ray tube which allows for improved electron emission characteristics. Particularly, a need for stable electron emission may exist. Such need may be met by the X-ray tube, the medical X-ray device and the method as defined in the independent claims. Embodiments of the invention are defined in the dependent claims.

According to a first aspect of the present invention, an X-ray tube is proposed which comprises an electron emitter, a field generator and a heater arrangement. The electron emitter comprises a substrate with an electron emission surface. This surface has a roughness which is adapted for field emission of electrons from this surface upon application of an electrical field. The field generator is adapted for generating an electrical field adjacent to the electron emission surface of the electron emitter for inducing field emission of electrons from the electron emission surface. The heater arrangement is adapted for heating the electron emission surface contemporaneous with the field emission of electrons.

According to another aspect of the invention, a method of operating an X-ray tube as defined above with respect to the first aspect is proposed. The method comprises generating an electrical field adjacent to the electron emission surface for inducing field emission therefrom and, preferably simultaneously therewith, supplying energy to the heater arrangement for heating the electron emission surface. As an option, the energy may be supplied to the heater arrangement prior to the generation of the electrical field for preconditioning the electron emission surface.

The electron emission surface of the electron emitter may comprise carbon nano-tubes (CNT). Such carbon nano-tubes may be coated onto a surface of the electron emitter substrate and may provide for an electron emission surface having a high roughness as the carbon nano-tubes may have a diameter of only a few nanometers but a length which is much longer such that a plurality of nano-tubes may protrude from the electron emission surface like needles thereby supporting electron emission due to a field effect.

The carbon nano-tubes may be coated directly onto a surface of the electron emitter substrate. No intermediate layer and/or binder may be used for attaching the carbon nano-tubes to the electron emitter substrate's surface.

During operating the X-ray tube, the electron emission surface may be heated to an elevated temperature of more than 100° C. but less than an upper temperature limit at which the thermionic electron emission becomes greater than 10% of the total electron emission or greater than 10% of the field induced electron emission. For example, the heater arrangement may be adapted for heating the electron emission surface to a temperature of between 100 and 1000 degree Celsius (° C.), preferably between 200 and 900° C. Heating the electron emission surface to such elevated temperatures of well above ambient temperature but preferable well below a temperature where substantial thermionic electron emission occurs has been observed to provide for stable electron emission characteristics when the field effect is used for electron emission. The heating of the electron emission surface should be significantly below a temperature at which substantial thermal electron emission occurs as the heating only further optimizes the field emission. The elevated temperature to which the electron emission surface is heated should remain below a temperature where the thermionic emission from the electron emission surface or the CNTs is significant. Preferably, such thermionic emission remains below 10% of the total emission.

The heater arrangement may be any arrangement adapted for directly or indirectly heating the electron emission surface of the electron emitter substrate. Any type of heating mechanism may be applied. For example, radiation heating using e.g. an infrared light source or a laser may be used for heating the electron emission surface. Alternatively, heat transport through a medium such as e.g. a channel or medium carrying heated liquid may be applied.

As a further example, the heater arrangement may use Joule heating, sometimes also referred to as resistive heating. For example, the heater arrangement may comprise a resistive element arranged at the electron emitter substrate for heating the electron emission surface upon application of an electrical current to the resistive element. A heater arrangement using Joule heating by arranging e. g. an electrically resistive element in thermal contact with the electron emission surface may allow for a simple option for heating this surface to elevated temperatures.

Furthermore, the X-ray tube may comprise a heater arrangement control which may be adapted for controlling an energy supply to the heater arrangement of the electron emitter for heating the electron emission surface to a predefined temperature. Therein, the heater arrangement may comprise a sensor for measuring the actual temperature of the electron emission surface such that based on such information the heater arrangement may be controlled to heat and hold the electron emission surface within a predetermined temperature range of e. g. in an average temperature +/− an acceptable temperature deviation of e. g. 50° C. Keeping the temperature of the electron emission surface in such predefined temperature range may help stabilizing electron emission characteristics.

In one implementation, the heater arrangement control may be adapted for controlling an electrical current supplied to a resistive element provided at the electron emitter substrate for heating the electron emission surface. Such supplying of an electrical current may be easily controlled thereby obtaining a stabilized elevated temperature of the electron emission surface.

The field generator of the proposed X-ray tube may comprise an electrically conductive grid. This grid may be arranged adjacent to the electron emission surface. The field generator may comprise electrical connections to the electron emission surface and to the grid such that a voltage generated in the field generator may be applied to these components thereby generating an electrical field between the electron emission surface and the grid. Due to such electrical field, electrons may be released from sharp tips comprised in the rough electron emission surface due to the field effect. The grid may furthermore be adapted such that these released electrons emitted from the electron emission surface may be transmitted through the grid towards an anode of the X-ray tube .

A medical X-ray device comprising an embodiment of the proposed X-ray tube may be any type of X-ray radiography equipment, for example a computer tomography (CT) device.

It is to be noted that possible features and advantages of embodiments of the invention are described herein partly with respect to a proposed X-ray tube, partly with respect to a proposed medical X-ray device and partly with respect to a proposed method of operating an X-ray tube. One skilled in the art will understand that the described features may be combined or exchanged between various embodiments in order to come to alternative embodiments and possibly enabling synergy effects.

### BRIEF DESCRIPTION OF THE DRAWINGS

In the following, embodiments of the present invention are described with respect to the attached drawing. However, neither the drawing nor the description shall be interpreted as limiting the invention.

FIG. 1 shows an X-ray tube according to an embodiment of the present invention.

The figure is only schematically and not to scale.

### DETAILED DESCRIPTION OF EMBODIMENTS

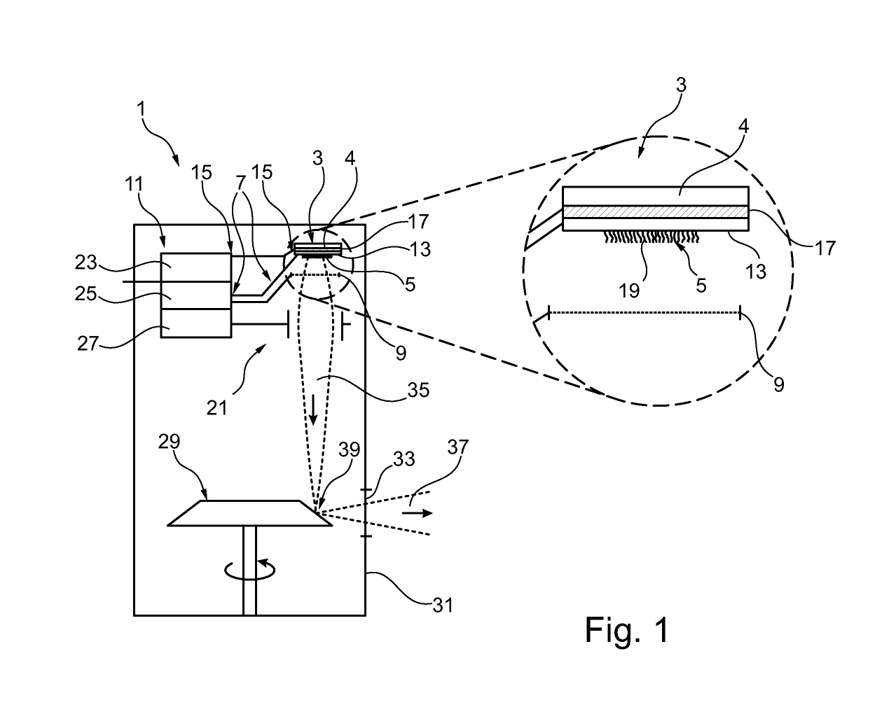

FIG. 1 shows an embodiment of an X-ray tube 1 according to an embodiment of the present invention.

In an evacuated space enclosed by a housing 31, an electron emitter 3 and a rotating anode 29 are arranged. The electron emitter 3 comprises an electron emitter substrate 4. On a surface 13 directing towards the rotating anode 29, an electron emission surface 5 is provided by coating this surface with a multiplicity of carbon nano-tubes 19.

Carbon nano-tubes (CNTs) are allotropes of carbon, typically with a cylindrical nano-structure. The length of the nano-tubes may be significantly larger than their diameters.

The nano-tubes 19 are arranged on the electron emission surface 5 such as to produce a very rough surface in which at least some of the nano-tubes 19 protrude towards the anode 29 like thin needles. Tips of the nano-tubes 19 may serve as a source for emitting electrons due to field emission as at such tips an electrical field generated adjacent to the electron emission surface may be locally concentrated and may have locally elevated field strength. Due to such elevated field strength, electrons comprised in the nano-tubes may be released at such tips. Therein, the nano-tubes may have metallic or semi-conducting characteristics, depending on their specific properties like rolling angle and radius of the nano-tubes.

The electrical field may be generated using an electrically conducting grid 9 arranged adjacent to the electron emission surface 5. A field generator control 23 comprised in a control 11 of the X-ray tube 1 may be electrically connected to both the electron emission surface 5 and the grid 11 such that a voltage of e.g. 2 kV may be applied between these components. The resulting electric field may have sufficient strength for releasing electrons from the nano-tube's tips due to field emission.

Electrons released from the electron emission surface 5 and forming an electron beam 35 may then be focused by an electron optics arrangement 21 controlled by an electron optics arrangement control 23 and may impinge onto the rotating anode 29 at a focal point 39. At such focal point 39, an X-ray beam 37 is generated as Bremsstrahlung. This X-ray beam 37 can exit the housing 31 through an X-ray transparent window 33.

In prior X-ray tubes using a field effect electron emitter, variations in the electron emission characteristics have been observed depending on various operation conditions of the X-ray tube 1. Such timely varying electron emission characteristic may result in a varying X-ray emission which could then negatively influence any application using the X-ray beam 37 such as for example a medical device in which the X-ray beam 37 is used for generating radiographs of an object to be examined.

It has now been found that the observed variations in electron emission characteristics may result from varying characteristics of the electron emission surface with the carbon nano-tubes.

For example, contaminations or adsorbents to the carbon nano-tubes may alter their electrical and/or geometrical properties thereby also altering electron emission characteristics. Furthermore, in conventional CNT electron emitters, an organic binder has frequently been used for binding the carbon nano-tubes to a surface of a substrate. However, such organic binder may outgas in the vacuum conditions within the X-ray tube 1 which outgasing may be detrimental to the vacuum and/or the electron emission characteristics.

It has now been observed that heating the carbon nano-tubes of the electron emission surface 5 to elevated temperatures well above the temperatures typically occurring in field emission emitters of conventional X-ray tubes may stabilize the electron emission characteristics of the electron emitter. Such heating procedure may be performed simultaneously with the operation of the electron emitter 3 in the X-ray tube 1, i. e. simultaneously to generating the electrical field adjacent to the electron emission surface 5. Additionally or alternatively, the heating procedure may precede the normal electron emission operation of the electron emitter 3 and may serve for preconditioning the X-ray tube 1.

The heating of the electron emission surface 5 may be performed such that temperatures of between 200 and 900° C., preferably between 400° C. and 900° C., are attained at the electron emission surface 5. Such temperatures are well above the ambient temperature or the temperature at which the electron emitter 3 would be without any additional heating. On the other side, the upper limit of the temperature range is well below typical temperatures used in thermionic emitters. In other words, while additional kinetic energy may be provided to electrons comprised in the carbon nano-tubes of the electron emission surface due to the elevated temperature, an upper limit for the temperature may be chosen such that this additional energy is still well below the work function energy of the material of the electron emission surface, i. e. for example of the carbon nano-tubes, such that no substantial flow of released electrons occurs due to thermionic emission.

Accordingly, despite the elevated temperature, the electron emitter 3 operates as a field effect electron emitter such that a flow of released electrons may be controlled by controlling the electrical field generated between the grid 9 and the electron emission surface 5. By varying such electric fields, an electron beam emitted towards the anode 29 may be varied and may for example be switched ON and OFF, thereby also enabling varying of the X-ray beam 37.

In order to heat the electron emission surface 5, a heater arrangement 15 is provided for the X-ray tube 1. While, in general, any heater arrangement enabling heating the electron emission surface 5 to the required elevated temperatures may be used, a specific type of heater arrangement 15 shall be described in the following in more detail. However, it shall be noted that other types of direct or indirect heater arrangements relying for example on resistive heating, radiation heating, conduction heating, induction heating or similar may be used.

In the embodiment shown in FIG. 1, a resistive element 17 is comprised in the substrate 4 of the electron emitter 3. Such resistive element 17 may form a part of the substrate 4 or may form the entire substrate 4. The resistive element may have an electrical resistance such that upon applying an electrical voltage and thereby inducing an electrical current, Joule heat is generated within the resistive element 17 and is transferred to the electron emission surface 5.

The resistive element 17 may be electrically connected via lines with an energy source of the heater arrangement control 23 for controllably supplying electrical energy to the resistive element 17.

For example, the heater arrangement control 23 may be adapted for controlling an electrical current supplied to the resistive element 17 such that the electron emission surface 5 is heated to a temperature within a predefined temperature range, for example to a temperature of 850° C. +/−50° C. Keeping the temperature of the electron emission surface 5 in such a temperature range may for example prevent contamination of the carbon nano-tubes of the electron emission surface 5 and may furthermore lower the work function necessary for releasing electrons from the carbon nano-tubes due to the field effect. As a result, the emission of electrons from the electron emission surface 5 may be stabilized.

The heater arrangement control 23 may be part of a general control 11 of the X-ray tube 1 comprised externally or internally within the X-ray tube 1 and further comprising a field generator control 25 for controlling the electrical voltage applied to the electrodes of the field generator 7 and further comprising an electron optics control 27 for controlling the electron optics 21.

It should be noted that the term “comprising” does not exclude other elements or steps and that the indefinite article “a” or “an” does not exclude the plural. Also elements described in association with different embodiments may be combined. It should also be noted that reference signs in the claims shall not be construed as limiting the scope of the claims.

### LIST OF REFERENCE SIGNS:

1 X-ray tube

3 electron emitter

4 electron emitter substrate

5 electron emission surface

7 field generator

9 grid

11 control

13 substrate surface

15 heater arrangement

17 resistive element

19 carbon nano-tubes

21 electron optics

22 heater arrangement control

25 field generator control

27 electron optics control

29 rotating anode

31 housing

33 window

35 electron beam

37 X-ray beam

39 focal spot

1. An X-ray tube (1), comprising:
an electron emitter (3) with an electron emission surface (5) having a roughness adapted for field emission of electrons therefrom upon application of an electrical field;
a field generator (7) for generating an electrical field adjacent to the electron emission surface of the electron emitter for inducing field emission of electrons therefrom; and
a heater arrangement (15) adapted for heating the electron emission surface contemporaneous with the field emission of electrons to an elevated temperature of more than 100° C. but less than an upper temperature limit at which the thermionic electron emission becomes greater than 10% of the field induced electron emission.

2. The X-ray tube of claim 1, wherein the electron emission surface comprises carbon nanotubes (19).

3. The X-ray tube of claim 2, wherein the carbon nanotubes are coated directly onto a surface of the electron emitter substrate.

4. The X-ray tube of claim 1, wherein the heater arrangement is adapted for heating the electron emission surface to an elevated temperature of between 100 and 1000° C.

5. The X-ray tube of claim 1, wherein the heater arrangement is adapted for heating the electron emission surface using one of Joule heating, radiation heating and heat transport through a medium.

6. The X-ray tube of claim 5, wherein the heater arrangement comprises a resistive element (17) arranged at an electron emitter substrate (4) for heating the electron emission surface upon application an electrical current to the resistive element.

7. The X-ray tube of claim 1, further comprising a heater arrangement control (23) adapted for controlling energy supply to the heater arrangement of the electron emitter for heating the electron emission surface to a predefined temperature range.

8. The X-ray tube of claim 7, wherein the heater arrangement control is adapted for controlling an electrical current supplied to a resistive element arranged at the electron emitter substrate of the electron emitter for heating the electron emission surface.

9. The X-ray tube of claim 1, wherein the field generator comprises an electrically conductive grid (11) arranged adjacent to the electron emission surface and the field generator furthermore comprises electrical connections to the electron emission surface and to a grid (9) for generating an electrical field between the electron emission surface and the grid, and
wherein the grid is adapted such that electrons emitted from the electron emission surface may be transmitted through the grid towards an anode of the X-ray tube.

10. A medical X-ray device comprising an X-ray tube according to claim 1.

11. A method of operating an X-ray tube (1) according to claim 1, the method comprising:
generating an electrical field adjacent to the electron emission surface (5) for inducing field emission of electrons therefrom; and
supplying energy to the heater arrangement (15) for heating the electron emission surface.

12. The method of claim 11, wherein the generation of the electrical field and the energy supply to the heater arrangement are performed simultaneously.

13. The method of claim 11, wherein the energy is supplied to the heater arrangement prior to the generation of the electrical field for preconditioning the electron emission surface.

14. (canceled)
